(19) United States
(12) Patent Application Publication
(10) Pub. No.: US 2025/0387817 A1
(43) Pub. Date: Dec. 25, 2025

(54) MSWI BOTTOM ASH AGGREGATE REFINEMENT PROCESS

(71) Applicant: Pure Recovery Group, L.P., Burlington (CA)

(72) Inventors: Thomas J. Lynott, III, Orwigsburg, PA (US); Thomas Lynott, IV, Orwigsburg, PA (US)

(21) Appl. No.: 19/241,362

(22) Filed: Jun. 17, 2025

Related U.S. Application Data
(60) Provisional application No. 63/661,630, filed on Jun. 19, 2024.

(51) Int. Cl. B09B 3/35; B03C 1/30; B09B 3/80; B09B 5/00; B09B 101/30; C02F 1/00

(52) U.S. Cl. CPC B09B 3/35; B03C 1/30; B09B 3/80; B09B 5/00; C02F 1/00; B09B 2101/30

(57) ABSTRACT

A refinement process to reclaim aggregates derived from municipal solid waste incineration (MSWI) bottom ash is tailored for use in the asphalt and cement industries. Initial size reduction achieves market-specific gradation to liberate fused particles, followed by magnetic separation for the recovery of ferrous and non-ferrous metals. The aggregate material undergoes density separation to remove organic contaminants and heavy metal-bearing particles across size-specific fractions. Finally, a targeted wash cycle using neutral pH water reduces the chloride concentrations of the final aggregate product. This multi-stage process produces a reclaimed aggregate with controlled absorption, loss on ignition, and contaminant levels, enabling its safe and effective use in encapsulated construction applications.

### CROSS-REFERENCE TO RELATED APPLICATION

This application claims the priority of U.S. Provisional Patent Application 63/661,630, filed Jun. 19, 2024, which is incorporated herein by reference in its entirety.

### BACKGROUND OF THE INVENTION

Municipal Solid Waste Incinerator (MSWI) bottom ash has long been explored as a potential source of recycled aggregates for use in encapsulated construction products such as asphalt and cement. However, despite its availability and cost-effectiveness, bottom ash aggregates often fail to meet the stringent requirements of these industries due to issues related to high absorption, loss on ignition (LOI), elevated chloride concentrations, and the presence of heavy metals and other environmental contaminants.

Existing technologies fall short in addressing these critical performance and environmental concerns, limiting the widespread adoption of MSWI-derived aggregates within the construction industry. There is, therefore, a need for a more robust and comprehensive refinement process that can reclaim valuable aggregate material from MSWI bottom ash, while ensuring that the final product meets industrial specifications for absorption, chloride content, LOI, and contaminant levels.

### SUMMARY OF THE INVENTION

The present invention provides a multi-stage process for refining aggregates sourced from MSWI bottom ash to meet the stringent specifications required by the asphalt and cement industries.

In a presently preferred embodiment, the process of the present invention includes an initial size reduction step to create a desired gradation and to liberate fused particles. Preferably, the process includes a magnetic separation step to recover ferrous and non-ferrous metals. Further, the process preferably includes an advanced density separation step to remove organic matter and heavy metal contaminants. Preferably, the present process also includes one or more targeted washing cycle steps to reduce chloride content.

Preferably, size-specific equipment is employed in the present process, including eddy current separators, heavy media cyclones, hydro cyclones, coal spirals, mineral spirals, and classifying cyclones.

By integrating size-specific equipment and a pH-balanced wash system, the process enables the reclamation of a clean aggregate product suitable for use within the construction industry. The clean aggregate produced exhibits minimized absorption, acceptable LOI, and reduced contaminants. This process also recovers valuable ferrous and non-ferrous metals, enhancing the economic feasibility of the operation.

### BRIEF DESCRIPTION OF THE DRAWINGS

FIG. 1 is a flow diagram showing a presently preferred embodiment of the process of the present invention.

FIG. 2 reports the results of the application of the process of FIG. 1 to four different sources of MSWI bottom ash.

FIG. 3 provides the results of analyses of the MSWI bottom ash of FIG. 2 confirming the successful treatment of the bottom ash by the process of the present invention as shown by industry standards.

### DETAILED DESCRIPTION OF THE INVENTION

The process begins with a size reduction step acting on MSWI bottom ash to the gradation required by end users. The size gradation required by end users depends on the intended use. For example, MSWI bottom ash employed as an aggregate replacement for asphalt, preferably has an average size of about 2 mm and a particle size distribution of about 10 mm to about 100 microns, but that can vary depending on the grading desired for the asphalt mix.

This size reduction step facilitates better downstream processing by liberating the fused particles, which may include aggregates bound with metals, organic matter, or other contaminants.

Once liberated, the materials in the process stream are conveyed through a series of magnetic separation devices, which selectively extract both ferrous and non-ferrous metals for recovery and potential reuse.

The residual aggregate material, now free of most metallic content, undergoes washing and advanced density separation. Size fractionation is applied to maximize the efficiency of separation; different size ranges are processed using tailored density separation equipment. An objective of the present process is to selectively isolate and remove both organic contaminants, which may otherwise contribute to high absorption and elevated LOI, as well as heavy metal-bearing particles, which pose environmental risks.

Following density separation, the refined aggregates are preferably subjected to a targeted wash cycle utilizing neutral pH water. This wash cycle serves to reduce contaminant concentrations, namely chlorides, within the aggregates to levels compatible with cement applications.

All water utilized in this system is preferably processed and reused within the system. The density separation water is preferably recycled through the system after filtering the contaminants from the desired water, forming a closed loop process. Preferably, the wash water is treated and filtered to remove soluble chlorides and then recirculated within the system. The closed loop practice of this process ensures environmental and economic sustainability.

The end product is a clean aggregate that meets or exceeds the requirements for use in asphalt and cement applications, including but not limited to specifications for absorption, LOI, chloride content, and environmental safety.

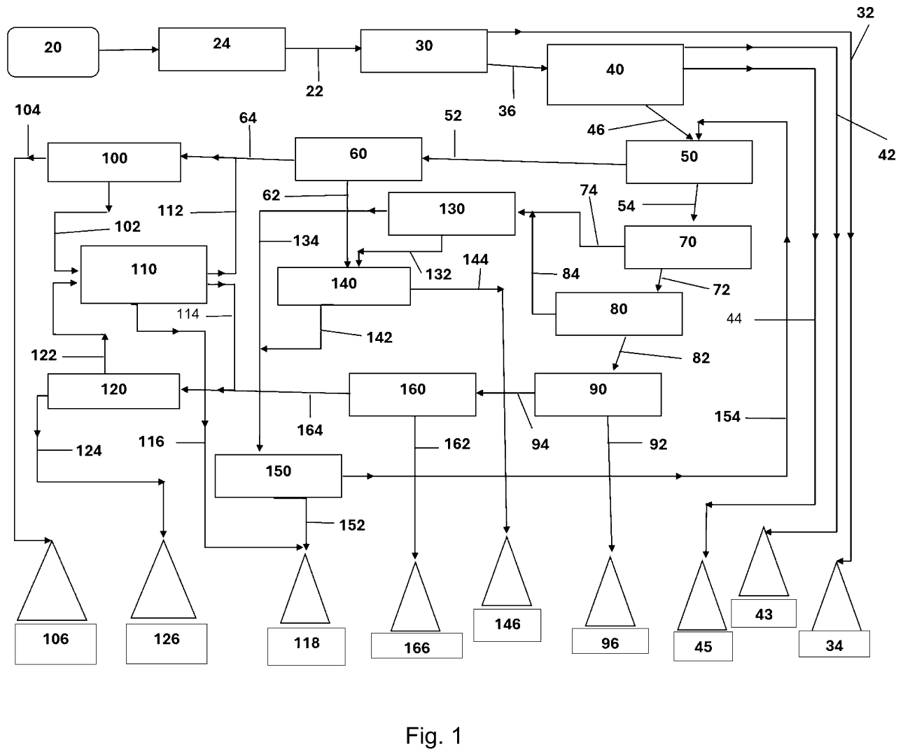

A presently preferred embodiment of the process of the present invention is illustrated in FIG. 1. MSWI bottom ash 10 is provided to a crusher 20 in which the average particle size of the MSWI bottom ash is reduced to a size appropriate for the intended use of the aggregate product.

The crushed ash process stream 22 is then conveyed to a first sizing screen 30 where the crushed ash process stream 22 is separated at 10 mm into an oversized material process stream 32 yielding separated oversized material 34, and a sized process stream 36 which is fed to an eddy current separator with a high gauss magnet 40.

This magnetic separator 40 separates the input material into three process streams: A ferrous material process stream 42 providing iron containing material 43, and a second zorba process stream 44 providing material comprising aluminum and other nonferrous metals 45 as a product of the process. The non-magnetic third output 46 from the eddy current separator is fed to a second sizing screen 50.

The second sizing screen 50 separates the material at 1 mm, with the assistance of clean processed density separation water 154 that is introduced to this screen, which thus provides a large material process stream 52 and a small material process stream 54.

The large material process stream 52 is in turn fed to a large density separator 60, while the small material process stream 54 is fed to a first small density separator 70.

The large density separator 60 provides a coarse low-density process stream 64 and a coarse high-density process stream 62, which is an aggregate material ready for the final wash cycle.

The high-density process stream 62 from the large density separator 60 is provided to a dewatering screen 100, utilizing 0.4 mm screens. By introducing the clean wash water 112 along with the density separated coarse aggregates 106 to this screen, the aggregates are washed and dewatered. The screen pitch and water flow are adjustable to maximize the washing efficiency and end moisture of the product. This step facilitates a separation of the high-density process stream 62 into a washed and dried coarse aggregate process stream 104 to provide a coarse aggregate 106 and the dirty wash water slurry 102 from the first dewatering screen 100 which is fed to the water filtration and treatment apparatus 110.

The water filtration and treatment apparatus 110 takes the dirty water slurries 102 and 122 from screens 100 and 120 and creates three particulate streams 112, 114, and 116.

The cleaned and treated water from the water filtration and treatment apparatus 110 is recycled back to the first dewatering screen 100 and the second dewatering screen 120 as clean wash water 112 and 114, while the ultra-fine particles 116 are concentrated and moved to the ultra-fine cake product.

The dirty wash water slurry 122 from the second dewatering screen facilitating the wash cycle on the fine aggregates 126 is recycled back to the water filtration and treatment apparatus 110, while the washed and dried fine aggregate stream 124 from the second dewatering screen 120 provides fine aggregate 126 as a product.

Returning to the output of the first density separator 60, the low-density process stream 64 is input to a third dewatering screen 140 which utilizes 5 mm screens. The supernatant from the third dewatering screen 140 provides a first dewatered organic stream 144 which comprises organic matter 146 as a by-product of the process.

The third dewatering screen 140 also yields a slurry of organic particulate stream 142 which is input into a water filtration apparatus 150. The second water filtration and treatment device 150 reclaims an ultra-fine particulate stream 152 which is added to the ultra-fine filter cake 118 product, while the filtered and cleaned water from the apparatus 150 is recycled as clean density separation water 154 back as an input to the second sizing screen 50.

The second sizing screen 50 provides a small material process stream 54 which serves as input to the first small density separator 70 which in turn provides a first fine high-density product stream 72 and a first fine low-density product stream 74. The low-density product stream 74 is fed into a classifier 130, while the high-density product stream is fed into a second small density separator 80. The second fine low-density product stream 84 from the second density separator 80 is also fed into the classifier 130, while the second fine high-density product stream 82 is fed into a high gauss wet magnet 90 which separates the high-density product stream 82 into a magnetic material stream 92 comprising of iron oxide 96 as a product of the process, and a non-magnetic material process stream 94. The non-magnetic material process stream 94 is input into a third small density separator 160, which provides a third fine high-density stream 162 comprising heavy metals 166 which have been separated in the process, and a third fine low-density stream 164 which is added to the second dewatering screen 120, this is the fine aggregate product ready for the final wash cycle.

Returning to the classifier 130, a coarse sized particulate stream 132 is output from the classifier 130 and input to the third dewatering screen 140 for further processing, while a fine sized particulate stream 134 is provided to the second water filtration, treatment and reclamation device 150 for processing.

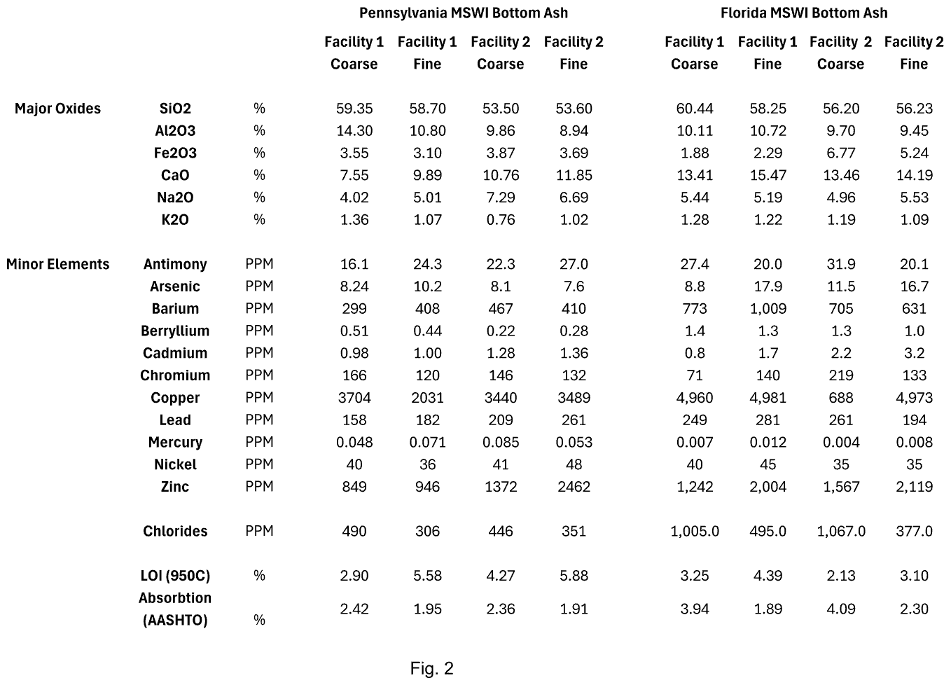

FIG. 2 reports the results of application of the present invention to MSWI bottom ash from four different sources. These results exemplify the quality of the aggregates with respect to the industry or application they can be used in. ASTM D692 shows the specifications for coarse aggregates to be used in asphalt and ASTM D1073 lays out the specifications for fine aggregates. When observing the suitability of the aggregates to be used as alternative raw materials for the cement industry, the chemical composition as well as physical properties must be tested. These must be evaluated on a kiln by kiln basis and mixed based on the kilns' products as well as raw materials.

Examples of crushers that can be employed in the present process include impact crushers capable of producing an average particle size between 3 and 1 mm, and having more than 80% between 10 mm and 100 microns.

An eddy current separator with a high gauss magnet which can be employed in the present process should be designed and tuned to recover metals from materials 10 mm and finer.

The density separators which can be used in the present process to remove organics include but are not limited to: coal spirals, hydro cyclones, and heavy media cyclones, all capable of making separations between 1.3 and 1.8 specific gravity.

The density separators which can be used in the present process to remove heavy metals from the desired aggregates include but are not limited to: mineral spirals and wet density separation tables capable of making a separation at or above 3.0 specific gravity.

Water filtration, treatment, and reclamation apparatus that can be employed in the present invention include but are not limited to: frame and plate press, belt press, chemical treatment, aeration, as well as reverse osmosis.

FIG. 2 reports the results of application of the process to four different sources of MSWI bottom ash. In each case, the process provided aggregate meeting the standards applicable for the use of the aggregate as a construction aggregate.

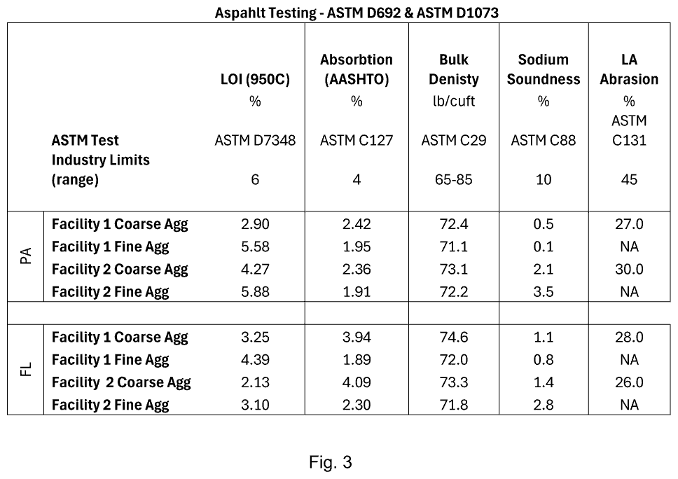

FIG. 3 confirms the successful treatment of the MSWI bottom ash produced by the sources of FIG. 2, as evaluated by standard industry methods.

Various modifications can be made in the details of the various embodiments of the processes and products of the present invention, all within the scope and spirit of the invention as defined by the appended claims.

### REFERENCE NUMERAL

10 MSWI ash
20 Crusher
22 Crushed ash process stream
30 First sizing screen
32 Oversized material process stream
34 Oversized material
36 Sized process stream
40 Magnetic separator eddy current separator with high gauss magnet
42 Ferrous material stream
43 Ferrous material
44 Zorba material stream
45 Zorba material
46 Non-magnetic material process stream
50 Second sizing screen
52 Large material process stream
54 Small material process stream
60 Large density separator
62 Coarse high-density stream
64 Coarse low-density stream
70 First small density separator
72 First fine high-density stream
74 First fine low-density stream
80 Second small density separator
82 Second fine high-density stream
84 Second fine low-density stream
90 High gauss wet magnet
92 Magnetic material stream
94 Non-magnetic material stream
96 Iron oxide
100 Dewatering screen A
102 Dirty wash water
104 Coarse aggregate stream
106 Coarse aggregate
110 Water filtration and treatment apparatus
112 Clean wash water
114 Clean wash water
116 Ultra-fine particle stream
118 Ultra-fine filter cake
120 Second dewatering screen B
122 Dirty wash water
124 Fine aggregate stream
126 Fine aggregate
130 Classifier
132 First sized particulate stream
134 Second sized particulate stream
140 Third dewatering screen
142 Dirty density separation water
144 First dewatered organic stream
146 Organic material
150 Water filtration apparatus
152 Ultra-fine particulate stream
154 Clean density separation water
160 Third small density separator
162 Third fine high-density stream
164 Third fine low-density stream
166 Heavy metals

1. A process for refining MSWI bottom ash aggregates comprising:
a) reducing the average particle size of the bottom ash aggregates;
b) crushing fused particles of the bottom ash aggregates to liberate constituent materials;
c) magnetically separating ferrous and non-ferrous metals;
d) separating the crushed fused particles by size;
e) separating constituents of the crushed fused particles by density for removal of organic and heavy metal contaminants; and
f) washing constituent materials of the crushed fused particles with neutral pH water to reduce chloride content.

2. The process of claim 1, wherein the liberated fused particles include aggregates, organic matter, heavy metals, and composite contaminants.

3. The process of claim 1, wherein the density separation includes use of size-specific equipment to improve removal efficiency of undesirable materials, organics and heavy metals.

4. The process of claim 1, wherein a neutral pH washing cycle results in an aggregate product with reduced chloride content suitable for cement applications.

5. The process of claim 1, wherein water employed in the process is filtered and treated to be reused within the system, operating as a closed loop.

6. An aggregate product reclaimed from MSWI bottom ash that:
a) exhibits absorption and LOI values within specifications for asphalt and cement industries;
b) contains chloride levels reduced to within acceptable industrial standards;
c) is free from hazardous concentrations of heavy metals and organics.

7. The product of the process of claim 1.

8. A process for refining MSWI bottom ash, the process comprising:
a) providing MSWI bottom ash;
b) crushing the MSWI bottom ash;
c) screening the crushed MSWI bottom ash and separating oversize material from the undersize MSWI bottom ash;
d) magnetically separating ferrous and aluminum material from the undersize MSWI bottom ash;
e) rescreening the undersize MSWI bottom ash after magnetic separation to provide an oversize product stream and an undersize product stream;
f) separating the oversize product stream by density to provide a high-density product stream and a low-density product stream; and
g) dewatering the high-density product stream.

9. The process according to claim 8 further comprising:
a) separating by density the undersize product steam into a high-density product stream and a low-density product stream;
b) magnetically separating iron oxide from the high-density product stream;
c) separating by density heavy metals from the high-density product stream; and
d) dewatering the high-density product stream.

10. The process according to claim 9 further comprising:
a) classifying the low-density product stream into a coarse sized particulate stream and a fine sized particulate stream;
b) dewatering the coarse sized particulate stream; and
c) feeding the fine sized particulate stream to a water filtration, treatment, and reclamation device.

11. The process of claim 10 wherein the undersize product stream produced after rescreening is also dewatered and fed to the water filtration, treatment and reclamation device.

12. The process of claim 8 wherein the water from the high-density product stream is fed to a water filtration, treatment and reclamation device.
